(19) United States
(12) Patent Application Publication
(10) Pub. No.: US 2018/0239324 A1
(43) Pub. Date: Aug. 23, 2018

(54) Electronic Device for Deactivating Attached Device Upon Detection of Fluid

(71) Applicant: Djamal Eddine Saou, Maspeth, NY (US)

(72) Inventor: Djamal Eddine Saou, Maspeth, NY (US)

(73) Assignee: Djamal Eddine Saou, Maspeth, NY (US)

(21) Appl. No.: 15/437,924

(22) Filed: Feb. 21, 2017

(51) Int. Cl. G05B 19/048; G08B 21/20; G08B 27/00; G08B 7/06; G05D 7/06; F24F 11/00

(52) U.S. Cl. CPC G05B 19/048; G08B 21/20; G08B 27/005; F24F 2011/0091; G05D 7/0629; F24F 11/0086; G08B 7/06

(57) ABSTRACT

The current subject matter relates to an electronic device that can detect leakage of a fluid from or production of a fluid by a device (e.g., a Heating, Ventilation and Air Conditioning (HVAC) system), deactivate the functionality of the device upon detection of the fluid, and notify a user about the deactivation of the device or other information relating to the device via a communication network. Related methods, techniques, apparatuses, systems, non-transitory computer program products, and articles are also described.

### TECHNICAL FIELD

The subject matter described herein relates to an electronic device that can detect leakage of a fluid from or production (e.g., excessive or abnormal production) of a fluid by a device (e.g., a Heating, Ventilation and Air Conditioning (HVAC) system), deactivate the functionality of the device upon detection of the fluid, and notify a user about the deactivation of the device via a communication network.

### BACKGROUND

Various devices prevalent in day-to-day lives of many individuals use fluids, such as: a Heating, Ventilation and Air Conditioning (HVAC) system; a boiler; a washer (e.g., a washing machine); and the like. Leakage or production (e.g., excessive or abnormal production) of fluid from these devices can pose a plethora of problems. One example of production of fluid can be generation of condensate in undesirable quantity by a HVAC unit. The leakage or production of fluid can make the floor wet, which can damage the floor, especially when the floor is made of wood or other fluid-absorbing material. The leakage or production of fluid can additionally result in slippery floors, which can cause accidents due to people slipping. Slippery floors can often lead to barricading the wet area from use, thereby wasting space.

All these problems are further aggravated by the lack of immediate detection of the leakage or production of fluid. In many cases, the leakage or production of fluid is usually not detected until the problem becomes severe—such as flooding of the premises—because users may not have the time to constantly diagnose, for leakage or production of fluid, all the devices in their establishments. There thus exists a need for an electronic device that detects leakage of fluid from or production of a fluid by a device, deactivates the functionality of the device upon detection of the leakage or production of fluid, and notifies a user about the leakage or production of fluid via a communication network.

### SUMMARY

An electronic device is described that can detect leakage of a fluid from or production (e.g., excessive or abnormal production) of a fluid by a device (e.g., a Heating, Ventilation and Air Conditioning (HVAC) system), deactivate the functionality of the device upon detection of the fluid, and notify a user about the deactivation of the device or other information relating to the device via a communication network.

In one aspect, an electronic device is described that can include a relay, a controller, and a sensor. The relay can be operably coupled to at least one device and configured to facilitate (e.g., allow or provide) power to the at least one device. The controller can be operably coupled to the relay. The sensor can be operably coupled to the controller. The sensor can be configured to detect leakage or production of fluid from the at least one device. The detection of the leakage or production can trigger a deactivation of the relay by the controller. The deactivation of the relay can deactivate the power to the at least one device.

In some variations, one or more of the following can be additionally implemented either individually or in any suitable combination. The at least one device can be a Heating, Ventilation and Air Conditioning (HVAC) unit. The at least one device can further include at least one of a washer and a boiler operably coupled to the relay via one or more zone valves. The sensor can include two or more probes. Conductivity between the two or more probes being activated when fluid touches the two or more probes. The sensor can be implemented within a non-conductive housing that has a cubical shape. Each of the width, length and height of the non-conductive housing can measure between 0.5 inches and 2.5 inches. The sensor can be incorporated in an absorbent pad placed underneath or in a vicinity of the at least one device. The sensor can be placed inside a drainage area that can collect the fluid leaking from or produced by the at least one device.

The electronic device can include a step-down transformer configured to reduce power input from a socket. The reduced power can power the relay, the controller, and the sensor. The electronic device can include an alarm device operably coupled to the controller. The controller can activate the alarm device upon the deactivation of the relay by the controller. The electronic device can include an alarm activation indicator that indicates a status of the alarm device. The status of the alarm device can characterize whether the alarm device is activated. The electronic device can include an alarm reset button to reset the alarm device. The electronic device can include an alarm test button to test the alarm device.

The electronic device can include a wireless unit operably coupled to the controller. The wireless unit can be configured to send a notification indicating the deactivation of the at least one device to a computing device via a communication network. The wireless unit can send the notification to the computing device via a computing server. The computing server can be operably coupled to the computing device and the wireless unit via the communication network. The electronic device can include an indicator that is activated when the wireless unit communicates with the computing server.

In another aspect, a computing server is described that can include a processor, one or more databases, an application programming interface, and at least one software development kit. The processor can be configured to receive data from an electronic device indicating deactivation of at least one device operably coupled to the electronic device. The one or more databases can be configured to store the data received from the processor. The application programming interface can be configured to receive the data from one of the processor and the one or more databases. The at least one software development kit can be configured to receive the data from the application programming interface. The at least one software development kit can be configured to send the data to an application executed on a computing device that implements an operating system corresponding to the at least one software development kit.

In some variations, one or more of the following can be additionally implemented either individually or in any suitable combination. The computing server can include another software development kit that can be configured to receive the data from the application programming interface. The other software development kit can be configured to send the data to the application executed on another computing device that implements another operating system corresponding to the other software development kit.

In yet another aspect, a controller of an electronic device can receive power from a power outlet. The controller can activate, upon the receipt of power, a relay operably coupled to at least one device. A sensor operably coupled to the controller can detect leakage or production of fluid from the at least one device. The controller can deactivate the relay upon the detection of the leakage or production of fluid. The deactivation of the relay can deactivate the at least one device.

In some variations, one or more of the following can be additionally implemented either individually or in any suitable combination. A component operably coupled to the controller can generate a notification indicating the deactivation of the at least one device. The component can be one of an alarm device physically implemented on the electronic device and a wireless unit. The wireless unit can send data characterizing the notification to a computing device via a cloud computing server.

The details of one or more variations of the subject matter described herein are set forth in the accompanying drawings and the description below. Other features and advantages of the subject matter described herein will be apparent from the description, the drawings, and the claims.

### DESCRIPTION OF DRAWINGS

FIG. 1 illustrates an electronic device that detects leakage of fluid from or production (e.g., excessive or abnormal production) of fluid by a device, deactivates the functionality of the device upon detection of the leakage or production of fluid, and notifies a user about the leakage via a communication network.

FIG. 2 is a flow diagram illustrating the functionality of the electronic device.

FIG. 3 illustrates the computing server hosting an application that notifies the user about a status of leakage of fluid from or production (e.g., excessive or abnormal production) of fluid by devices attached to an electronic device.

FIG. 4 is a flow diagram illustrating a functionality of the computing server.

FIGS. 5-8 illustrate screens of the application that notifies the user about a status of leakage of fluid from or production (e.g., excessive or abnormal production) of fluid by devices operably coupled to an electronic device.

Like reference symbols in the various drawings indicate like elements.

### DETAILED DESCRIPTION

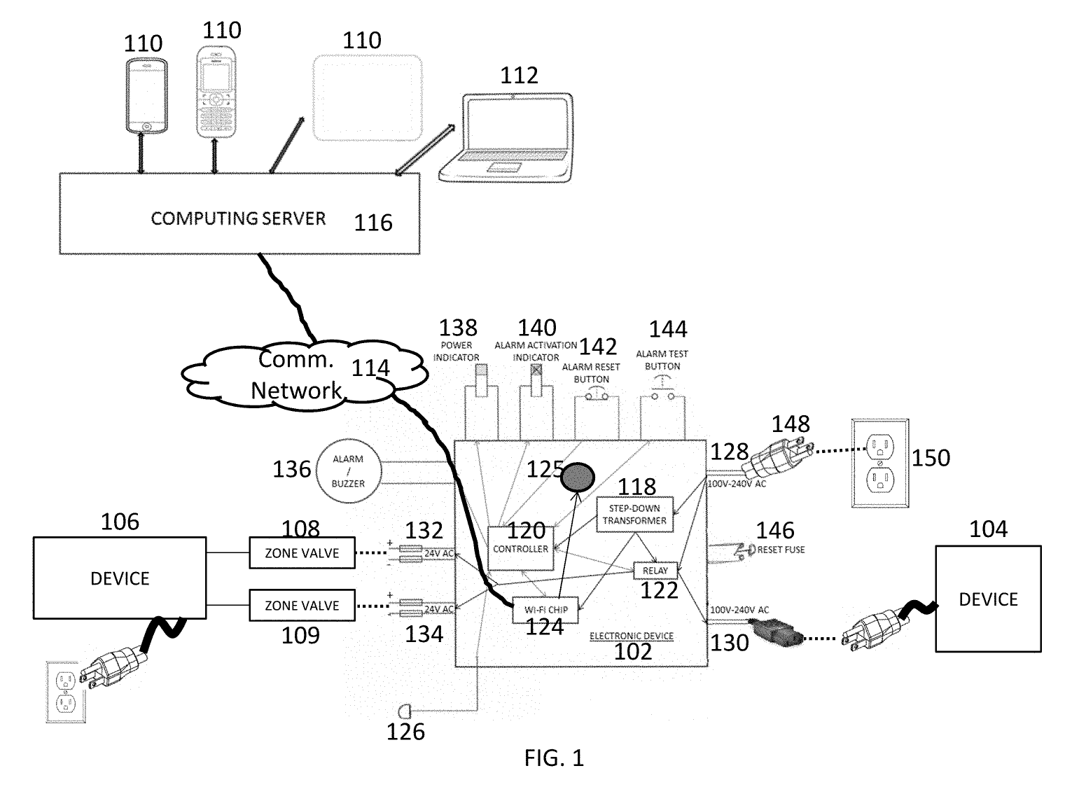

FIG. 1 illustrates an electronic device 102 that detects leakage or production (e.g., excessive or abnormal production) of a fluid from one or more devices 104 and 106, deactivates the functionality of those one or more devices 104 and 106 upon detection of the leakage or production of fluid, and notifies a computing device 110 and/or 112 configured to be operated by a user about the leakage or production of fluid via a communication network 114 and a computing server 116. In one example: the device 104 can be a Heating, Ventilation and Air Conditioning (HVAC) unit; the device 106 can be a boiler or a washing machine; the fluid can be water; and/or the leakage or production of fluid by the HVAC unit can refer to the undesirable condensate produced by the HVAC unit. The electronic device 102 can be operably coupled to the device 106 via zone valves 108 and 109, which can control the flow of fluid in the device 106.

The electronic device 102 can include a step-down transformer 118, a controller 120, a relay 122, a wireless unit (also referred to as a WiFi chip) 124, an indicator 125, and a sensor 126. The electronic device 102 can also include an input port 128, output ports 130, 132 and 134, and an alarm (e.g., a buzzer or an alarm device) 136. The electronic device 102 can further include a power indicator 138, an alarm activation indicator 140, an alarm reset button 142, an alarm test button 144, and a reset fuse 146.

A user can insert a male plug 148 of the electronic device 102 into a socket 150. While a male plug is described, any alternate connector can instead be attached to the electronic device 102 to receive power. As a result of the plugging in, the electronic device 102 can receive, via the input port 128, alternating current at a voltage between 100 volts and 240 volts. The step-down transformer 118 can reduce, when the electronic device 102 is plugged into the socket 150, the voltage of the alternating current from between 100 volts and 240 volts to 24 volts, which can then power the controller 120, the relay 122, and the wireless unit 124. The controller 120 can activate the one or more power indicator light emitting diodes 138. The controller 120 can activate the relay 122. The activated relay 122 can facilitate powering of device 106 with the alternating current being output at 24 volts, and the device 104 with the alternating current at 100-240 volts.

The sensor 126 can be a fluid sensor, which can detect leakage or production of fluid. In some implementations, the sensor 126 can be multiple sensors connected with each other to maximize space over which the fluid can be detected. The sensor 126 can be inserted in a mat or a pad. The pad can absorb fluids so as to minimize the damage on the surface (e.g., floor or ground) due to the fluid. Such absorbent pads can be made of superabsorbent polymer, polyacrylate copolymer, polyacrylamide copolymer, cellulose, fiber, any other absorbing material, or any combination thereof. The pad can be placed at a location that is underneath both the device 104 and device 106. In an alternate implementation, the pad can be placed at a location in the vicinity of both the device 104 and device 106.

The sensor 126 can have two probes (e.g., poles or electrodes), and can act like a switch as follows. When water touches the two probes, the switch can activate such that there is conductivity between the two probes. The conductivity can be measured in millivolts. The sensor 126 can be implemented within a non-conductive housing. Each dimension of the housing can be 1.5 inches. Although the size of each dimension of the housing is described as 1.5 inches, in another implementation each dimension can be any value between 0.5 inches and 2.5 inches. While the sensor 126 can be incorporated in an absorbent pad, as described above, in an alternate implementation the sensor 126 can be placed inside a drainage area (e.g., a drain pan) that may be located underneath or in the vicinity of the devices 104 and/or 106. The sensor 126 can, upon detection of leakage or production of fluid, notify—e.g., by sending data indicating a notice—the controller 120 regarding the leakage or production of fluid.

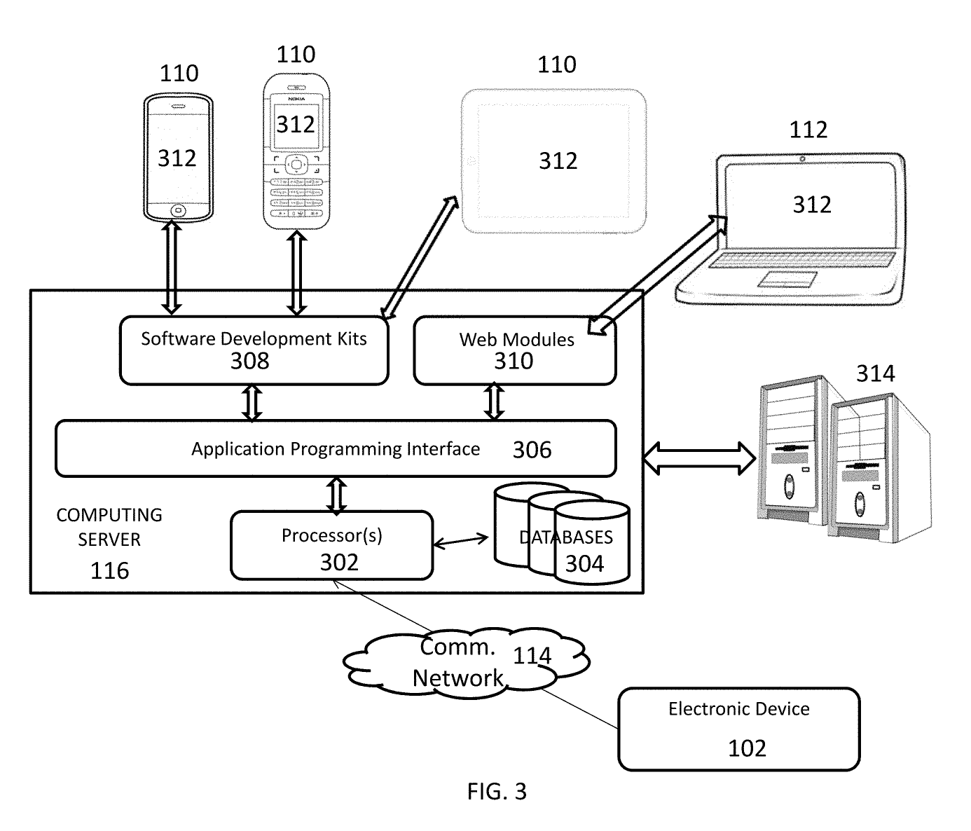

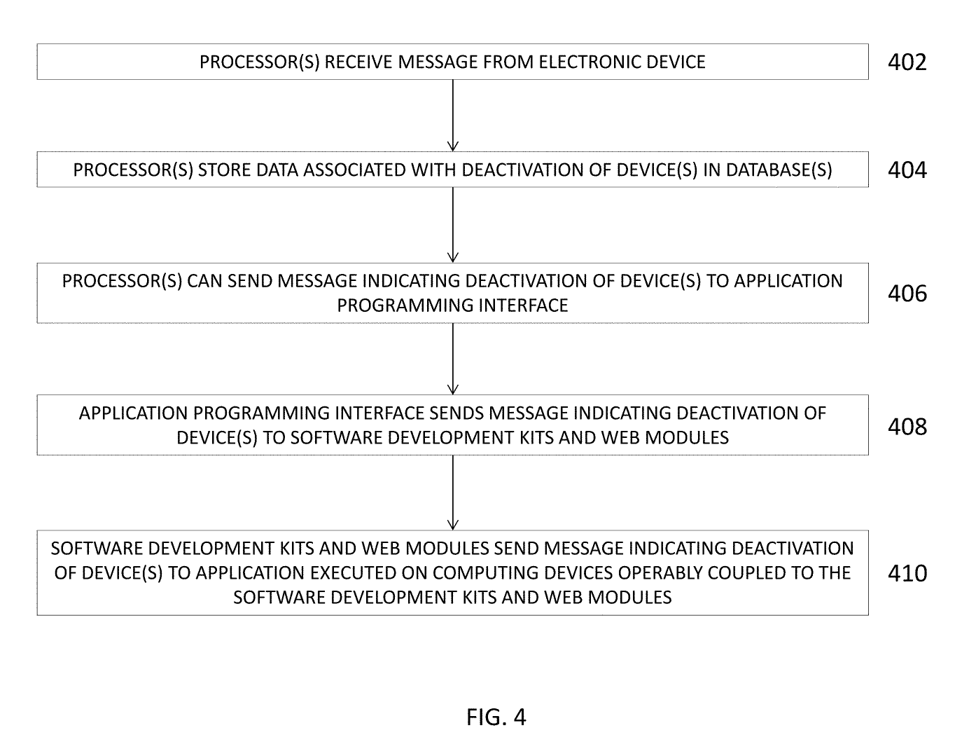

The controller 120 can deactivate the relay 122 upon receipt of the notice of leakage or production of fluid. The deactivated relay 122 can prevent current from going to the device 104, thereby deactivating the device 104. When the relay 122 is activated, the zone valves 108 and 109 can facilitate the receipt of fluid by the device 106 for its operations, but when the relay 122 is deactivated, the zone valves 108 and 109 can deactivate to shut the fluid supply for the operations of the device 106, thereby deactivating the device 106. The deactivation of the relay 122 therefore deactivates each of the devices 104 and 106. The controller 120 can activate the alarm 136 and the alarm activation indicator light emitting diodes 140 upon deactivation of the relay 122. The controller 120 can send a message indicating the deactivation of the devices 104 and 106 to the computing devices 110 and/or 112 of the user via the wireless unit 124 and the computing server 116. The wireless unit 124 can activate the indicator 125 when the wireless unit 124 communicates with the computing server 116. The indicator 125 can be a lighting unit, which can include one or more light emitting diodes, one or more compact fluorescent lamps, and/or the like. In an alternate implementation, the indicator 125 can be an audio indicator such as a buzzer. This sending of the message to the computing devices 110 and/or 112 via the wireless unit 124 and the computing server 116 is described in greater detail by FIGS. 3 and 4.

The term fluid used herein can refer to water. Even though water is described, in other implementations the term fluid can refer to other fluids, such as oil, paint, any other fluid, any combination thereof, or a combination of water with any other one or more fluids. The device 104 can be a HVAC unit, or any other device that is powered by 100-240 volts and is capable of producing fluid such as water (e.g., condensate, as generated by the HVAC unit). While a single output port 130 is described that outputs a voltage between 100 volts and 240 volts to power the device 104, in other implementations there may be either no such output port or there may be more than one such output ports. The device 106 can be one of a boiler, a washer (e.g., a washing machine), and the like. The device 106 can be operably coupled to the output ports 132 and 134 via zone valves 108 and 109, respectively. The zone valves 108 and 109 can control the flow of fluid in the device 106. When the relay 122 is activated, the zone valves 108 and 109 allow the device 106 to receive fluid for its operations. However, when the relay 122 is deactivated, the zone valves 108 and 109 deactivate to shut the fluid supply for its operations, thereby deactivating the device 106. While two output ports 132 and 134 and a single device 106 connected thereto are described, in other implementations there may be no such output ports and devices, while in further implementations there may be any number of such output ports and devices.

Each computing device 110 can be a cellular smart phone, a tablet computer, a phablet computer, and/or any other computing device that can communicate with software development kits (SDKs). Each computing device 112 can be a laptop computer, a desktop computer, and/or any other computing device that can communicate with web modules. The communication network 114 can be a local area network, a wide area network, a metropolitan area network, internet, intranet, Bluetooth network, infrared network, and/or any other network. The computing server 116 can be a cloud computing server. Although a cloud computing server is described, in alternate implementations any other server can be used instead. The step-down transformer 118 can be any one of: an autotransformer, a capacitor voltage transformer, a distribution transformer, a power transformer, a phase angle regulating transformer, a Scott connection transformer (which can also be referred to as a Scott-T transformer), a polyphaser transformer, a grounding transformer, a leakage transformer, a resonant transformer, an audio transformer, an output transformer, an instrument transformer, a pulse transformer, or any other transformer.

The controller 120 can be a microcontroller, which can operate on a single integrated circuit. The microcontroller can include one or more central processing units (which can also be referred to as processor cores), memory, and programmable peripheral devices for input and output. This memory can include a random access memory (RAM), a Ferroelectric RAM, a NOR flash, and/or a one-time programmable read only memory. While the wireless unit 124 has been shown in FIG. 1 as being separate from the controller 120, in other implementations the wireless unit 124 can embedded within the controller 120.

The relay 122 can be an electrically operated switch. Activation of the relay 122 can turn the switch on and completes the circuit, whereas deactivation of the relay 122 can turn the switch off and break the circuit. The relay 122 can be an electromagnetic relay or a solid-state relay. The relay 122 can be a 15 ampere relay—that is, the relay 122 can be a switching device that can operate on 15 amperes. Although a 15 ampere relay is described, in other implementations any other relay can be used that can have other amperage values, such as 20 amperes.

The power indicator 138 can include one or more light emitting diodes. Although light emitting diodes are described, in other implementations that power indicator 138 can include any other lighting device such as compact fluorescent lamps. The alarm activation indicator 140 can indicate, via a lighting device such as one or more light emitting diodes, the current status—activation or deactivation—of the alarm 136. The alarm reset button 142 can reset the alarm 136. The alarm test button can test the alarm 136. The reset fuse 146 can reset the fuse (which can also be referred to as a circuit breaker). The reset fuse 146 can also be referred to as a polymeric positive temperature coefficient device.

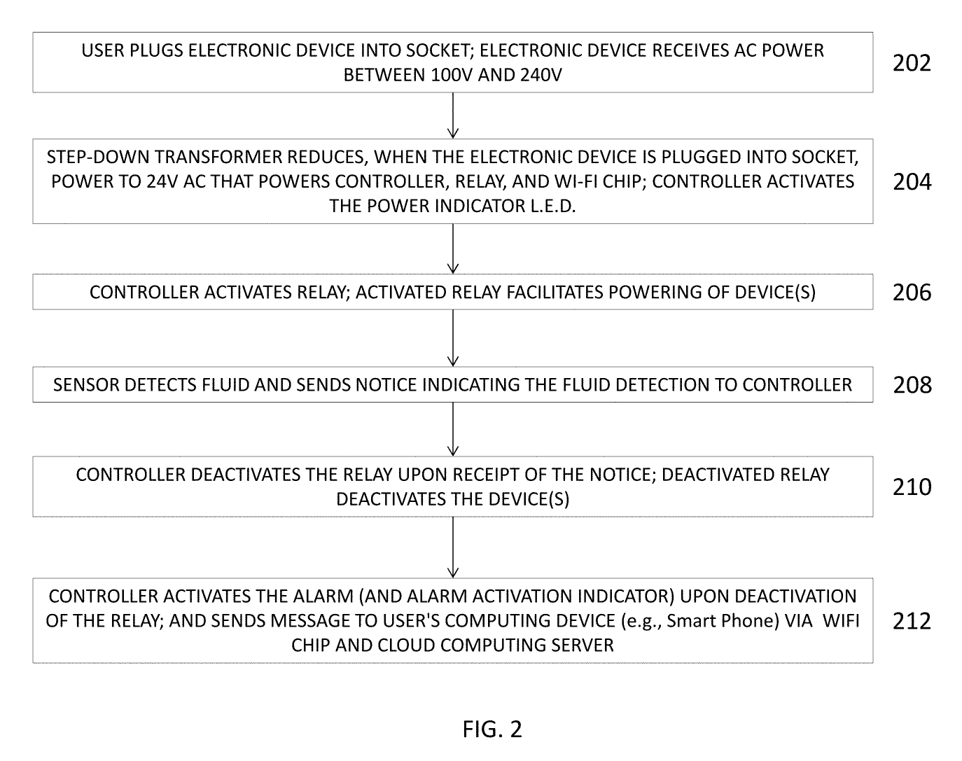

FIG. 2 is a flow diagram illustrating the functionality of the electronic device 102. A user can plug in, at 202, the electronic device 102 into the socket 150. As a result of the plugging in, the electronic device 102 can receive alternating current with a voltage between 100 volts and 240 volts. A step-down transformer 126 can reduce, at 204 and when the electronic device 102 is plugged into the socket 150, the voltage of alternating current from between 100 volts and 240 volts to 24 volts, which then powers a controller 120, a relay 122, and a wireless unit 124. The controller 120 can activate the one or more power indicator light emitting diodes 138. The controller 120 can activate, at 206, the relay 122. The activated relay 122 can facilitate control of the functionality of: device 106 with the alternating current being output at 24 volts, and the device 104 with the alternating current being output at 100-240 volts.

The sensor 126 can detect leakage or production (e.g., excessive or abnormal production) of fluid at 208. The sensor 126 can, upon detection of leakage or production of fluid, notify—e.g., by sending data indicating a notice—the controller 120 regarding the leakage or production of fluid. The controller 120 can deactivate, at 210, the relay 122 upon receipt of the notice of leakage or production of fluid. The deactivated relay 122 can prevent current from going to the device 104, thereby deactivating the device 104. The deactivated relay 122 can further prevent current from going to the zone valves 108 and 109, which accordingly deactivate, thereby shutting the supply of fluid for operations/functioning of the device 106, thereby deactivating the device 106 as well. The controller 120 can activate, at 212, the alarm 136 and the alarm activation indicator light emitting diodes 140 upon deactivation of the relay 122. The controller 120 can send a message indicating the deactivation of the devices 104 and 106 to the computing device 110 and/or 112 of the user via the wireless unit 124 and the cloud computing server 116. This sending of the message via the wireless unit 124 and the cloud computing server 116 is described in greater detail below by FIGS. 3 and 4.

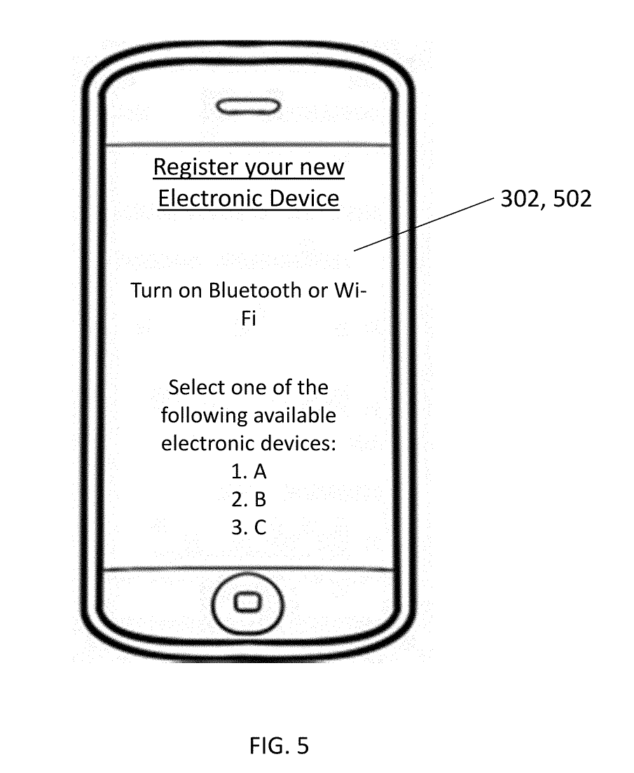

FIG. 3 illustrates the computing server 116 hosting an application that notifies the user about a status of leakage or production (e.g., excessive or abnormal production) of fluid from devices 104 and 106 attached to the electronic device 102. The functionality of the application is discussed in greater detail below by FIGS. 5-8.

The computing server 116 can include one or more processors 302, one or more databases 304, an application programming interface 306, software development kits 308, and web modules 310. The one or more processors 302 can receive, from the electronic device 102 and via a communication network 114, a message indicating the deactivation of the devices 104 and 106. The one or more processors 302 can store the data associated with the deactivation of the devices 104 and 106 in one or more databases 304. The one or more processors 302 can send the message indicating the deactivation of the devices 104 and 106 to the application programming interface 306. The application programming interface 306 can send the message indicating the deactivation of the devices 104 and 106 to the software development kits 308 and web modules 310. An application 312 executed on the computing devices 110 can access the message and communicate with the computing server 116 using the software development kits 308. The application 312 executed on the computing devices 112 can access the message and communicate with the computing server 116 using the web modules 310.

The one or more databases 304 can store deactivation data—such as identification of the electronic device which deactivates associated devices, time of deactivation, and the like—associated with all the devices that have been registered using the application 312. The one or more databases 304 can thus save data for not only the electronic device 102, but also other such electronic devices used by the same user and/or other users. The storage of data associated with all electronic devices can enable the user associated with each electronic device to review, by using the application 312, the status of his/her/its respective electronic device.

A computing device 314 can control the functionality of the computing server 116. The computing device 314 can be accessed only by selective users, such as database administrators, who have authentication data such as a username and a password for accessing the computing device 314. The computing device 314 can be either attached to the computing server 116 or connected to the computing server 116. In the implementations where the computing device 314 is connected to the computing server 116, the connection may be wired or wireless via a communication network such as a local area network, a wide area network, a metropolitan area network, internet, intranet, Bluetooth network, infrared network, and/or any other network.

Each database 304 can be a hierarchical database, a relational database (e.g., a SQL database), or a non-relational database. The database 304 can be either a columnar database or a row based database. In one implementation, the database 304 can be an in-memory database that is embedded within the computing server 116, as shown in FIG. 3. In an alternate implementation, the database 304 can be remote to the computing server 116 and can be operably coupled to the computing server 304 via a communication network, which can be one or more of: a wired connection, a local area network, a wide area network, internet, intranet, Bluetooth network, infrared network, and any other communication networks.

The software development kits (SDKs) 308 can include multiple SDKs. Each SDK 308 can be a set of software development tools that allows the computing device 110 to access the data in the computing server 116 so as to execute the application 302. In some implementations, at least one of the SDKs 308 can display, on the application 302, advanced functionalities, advertisements, push notifications and the like. Different SDKs 308 can be used for different computing devices 110 based on the operating system—e.g., IOS (also referred to as iOS or iPhone Operating System), ANDROID operating system, and the like—of each computing device 110. E.g., the application 302, when an Android application, may require a SDK with Java. Similarly, the application 302, when an iOS application, may require an iOS SDK with SWIFT. Further, the application 302, when a MICROSOFT WINDOWS application, may require a .NET Framework SDK. While SDKs 308 are shown as being implemented in the computing server 116, in some implementations, additional SDKs may be implemented in the computing devices 110 and/or 112 to collect analytics and data about activity of a user. The web modules 310 can perform the operations similar or same as those performed for the computing devices 110 by the SDKs 308, but for computing devices 112.

The computing device 314 can be a laptop computer, a desktop computer, a tablet computer, a cellular smart phone, a phablet, any other computing device, and/or any combination thereof. The user described herein can refer to a human being. In alternate implementations, the user can be a machine. A user operating the electronic device 102 can be separate and different from another user using the application 312. In some implementations, more than one user can use a same application 312. In one implementation, more than one user can operate the electronic device 102. In some implementations, multiple users can be registered with a single electronic device 102.

FIG. 4 illustrates a functionality of the computing server 116 hosting an application 312 that notifies the user about a status of leakage or production (e.g., excessive or abnormal production) of fluid from devices 104 and 106 attached to the electronic device 102. The one or more processors 302 can receive, at 402 and from the electronic device 102 and via a communication network 114, a message indicating the deactivation of the devices 104 and 106. The one or more processors 302 can store, at 404, the data associated with the deactivation of the devices 104 and 106 in one or more databases 304. The one or more processors 302 can send, at 406, the message indicating the deactivation of the devices 104 and 106 to the application programming interface 306. The application programming interface 306 can send, at 408, the message indicating the deactivation of the devices 104 and 106 to the software development kits 308 and web modules 310. At 410, an application 312 executed on the computing devices 110 can access the message and communicate with the computing server 116 using the software development kits 308. At 410, the application 312 executed on the computing devices 112 can access the message and communicate with the computing server 116 using the web modules 310.

FIG. 5 illustrates a screen 502 of the application 302 that displays a list of unregistered electronic devices—A, B, and C in the implementation shown by screen 502—that are detected over a communication network, such as a Bluetooth or WiFi network. In one implementation, those electronic devices may be located in the vicinity of each other, such as in different rooms of a building. When a user selects the desirable electronic device on the screen 502, the application 302 can allow the user to register that electronic device with the application 302.

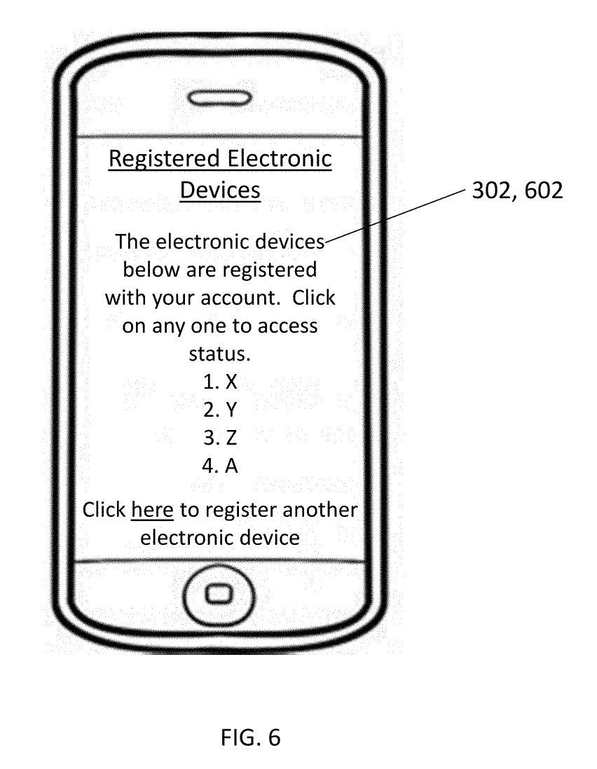

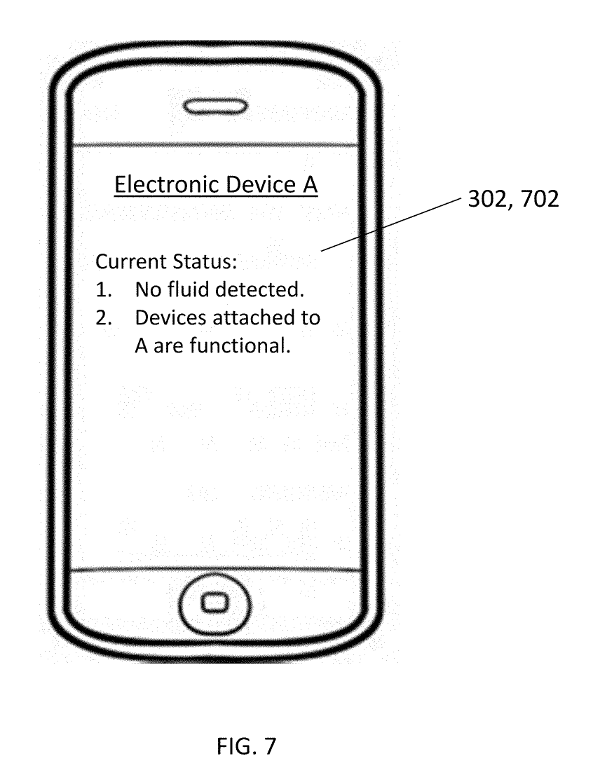

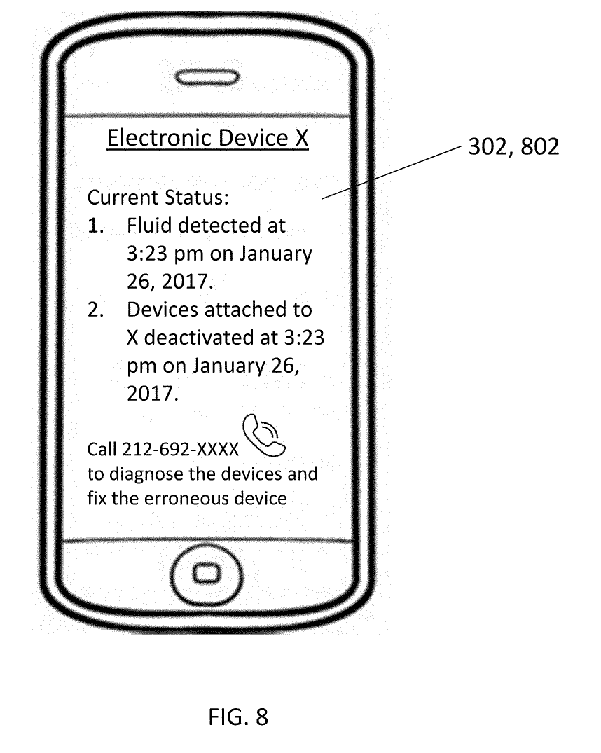

FIG. 6 illustrates a screen 602 of the application 302 that displays electronic devices—X, Y, Z, and A in the implementation shown by screen 502—registered by a user. In the shown example, electronic device A, which was initially unregistered, has been registered by the user after the screen 502 is displayed. When a user selects the desirable electronic device on the screen 602, the application 302 can display the activation status (which can also be referred to as the deactivation status) of the selected electronic device, as described below by FIGS. 7 and 8.

FIG. 7 illustrates a screen 702 of the application 302 that displays a current status of a registered electronic device that is selected on the screen 602 (of FIG. 6) and that is detected as not leaking or producing fluid.

FIG. 8 illustrates a screen 802 of the application 302 that displays a current status of a registered electronic device that is selected on the screen 602 (of FIG. 6) and that is detected as leaking or producing fluid. The screen 802 can additionally display details of an entity (e.g., an organization or an individual) that the user can contact to get the leakage or production (e.g., excessive or abnormal production) of fluid diagnosed.

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (e.g., magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the subject matter described herein can be implemented on a computer that can receive data from the one or more users via a keyboard, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, a front-end component, and one or more combinations thereof. The back-end component can be a data server. The middleware component can be an application server. The front-end component can be a client computer having a graphical user interface or a web browser, through which a user can interact with an implementation of the subject matter described herein. The components of the system can be interconnected by any form or medium of digital data communication, such as a communication network. Examples of communication networks can include a local area network, a wide area network, a metropolitan area network, internet, intranet, Bluetooth network, infrared network, or any other network.

The computing system can include clients and servers. A client and server can be generally remote from each other and can interact through a communication network. The relationship of client and server can arise by virtue of computer programs running on the respective computers and having a client-server relationship with each other.

The processes described herein can be implemented by one or more data processors either within a single computing system or distributed among two or more computing systems. Related computer program products and computer systems are also described. The computer program products can comprise non-transitory computer readable media storing instructions, which when executed by at least one data processor of one or more computing systems, can cause the at least one data processor to perform operations herein. The computer systems may include one or more data processors and a memory coupled to the one or more data processors. The memory can temporarily or permanently store instructions that cause at least one processor to perform one or more of the operations described herein.

Although a few variations have been described in detail above, other modifications can be possible. For example, the logic flows or sequences described herein do not require the particular order shown, or sequential order, to achieve desirable results. Further, the features described in different implementations are interchangeable and/or additive to create further implementations, which are also within the scope of this patent application. Other implementations may be within the scope of the following claims.

1. An electronic device comprising:
a relay operably coupled to at least one device and configured to facilitate power to the at least one device;
a controller operably coupled to the relay; and
a sensor operably coupled to the controller, the sensor configured to detect leakage or production of fluid from the at least one device, the detection of the leakage or production triggering a deactivation of the relay by the controller, the deactivation of the relay deactivating the power to the at least one device.

2. The electronic device of claim 1, wherein the at least one device is a Heating, Ventilation and Air Conditioning (HVAC) unit.

3. The electronic device of claim 2, wherein the at least one device further comprises at least one of a washer and a boiler operably coupled to the relay via one or more zone valves.

4. The electronic device of claim 1, wherein the sensor comprises two or more probes, conductivity between the two or more probes being activated when fluid touches the two or more probes.

5. The electronic device of claim 1, wherein the sensor is implemented within a non-conductive housing that has a cubical shape, each of the width, length and height of the non-conductive housing measuring between 0.5 inches and 2.5 inches.

6. The electronic device of claim 1, wherein the sensor is incorporated in an absorbent pad placed underneath or in a vicinity of the at least one device.

7. The electronic device of claim 1, wherein the sensor is placed inside a drainage area that is configured to collect the fluid leaking from or produced by the at least one device.

8. The electronic device of claim 1, further comprising a step-down transformer configured to reduce power input from a socket, the reduced power powering the relay, the controller, and the sensor.

9. The electronic device of claim 1, further comprising an alarm device operably coupled to the controller, the controller activating the alarm device upon the deactivation of the relay by the controller.

10. The electronic device of claim 9, further comprising an alarm activation indicator that indicates a status of the alarm device, the status of the alarm device characterizing whether the alarm device is activated.

11. The electronic device of claim 9, further comprising an alarm reset button to reset the alarm device.

12. The electronic device of claim 9, further comprising an alarm test button to test the alarm device.

13. The electronic device of claim 1, further comprising a wireless unit operably coupled to the controller, the wireless unit configured to send a notification indicating the deactivation of the at least one device to a computing device via a communication network.

14. The electronic device of claim 13, wherein the wireless unit sends the notification to the computing device via a computing server, the computing server operably coupled to the computing device and the wireless unit via the communication network.

15. The electronic device of claim 13, further comprising an indicator that is activated when the wireless unit communicates with the computing server.

16. A computing server comprising:
a processor configured to receive data from an electronic device indicating deactivation of at least one device operably coupled to the electronic device;
one or more databases configured to store the data received from the processor;
an application programming interface configured to receive the data from one of the processor and the one or more databases; and
at least one software development kit configured to receive the data from the application programming interface, the at least one software development kit configured to send the data to an application executed on a computing device that implements an operating system corresponding to the at least one software development kit.

17. The computing server of claim 15, further comprising:
another software development kit configured to receive the data from the application programming interface, the other software development kit configured to send the data to the application executed on another computing device that implements another operating system corresponding to the other software development kit.

18. A method comprising:
receiving, by a controller of an electronic device, power from a power outlet;
activating, by the controller and upon the receipt of power, a relay operably coupled to at least one device;
detecting, by a sensor operably coupled to the controller, leakage or production of fluid from the at least one device; and
deactivating, by the controller, the relay upon the detection of the leakage or production of the fluid, the deactivation of the relay deactivating the at least one device.

19. The method of claim 17, further comprising:
generating, by a component operably coupled to the controller, a notification indicating the deactivation of the at least one device.

20. The method of claim 18, wherein the component is one of an alarm device physically implemented on the electronic device and a wireless unit.

21. (canceled)
